(19) United States
(12) Patent Application Publication
(10) Pub. No.: US 2025/0238289 A1
(43) Pub. Date: Jul. 24, 2025

(54) SYSTEMS AND METHODS FOR A GENERATIVE ARTIFICIAL INTELLIGENCE MODEL WITH PROACTIVE CONTENT GENERATION

(71) Applicant: Wells Fargo Bank, N.A., San Francisco, CA (US)

(72) Inventors: Azita Asefi, Vacaville, CA (US); Alan W. Hecht, Chanhassen, MN (US); Traci Nguyen, San Francisco, CA (US); Dennis E. Montenegro, Concord, CA (US); Julio Jiron, San Bruno, CA (US); Darius A. Miranda, San Francisco, CA (US); Muhammad Farukh Munir, Pittsburg, CA (US); Ashish B. Kurani, Hillsborough, CA (US)

(73) Assignee: Wells Fargo Bank, N.A., San Francisco, CA (US)

(21) Appl. No.: 18/417,192

(22) Filed: Jan. 19, 2024

(51) Int. Cl. G06F 9/54; G06F 40/40; G06Q 20/20; G06Q 20/40

(52) U.S. Cl. CPC G06F 9/542; G06F 40/40; G06Q 20/20; G06Q 20/4093

(57) ABSTRACT

A provider computing system can include at least one processing circuit having at least one processor coupled to at least one memory device. The at least one memory device can store instructions thereon that, when executed by the at least one processor, cause the at least one processing circuit to detect initiation of a session to access an account by a user device of a user, detect correlations between an event and one or more previous occurrences of one or more events similar to the event, generate a plurality of actions to address the event, transmit one or more signals to cause the user device to display a user interface including selectable elements to indicate the plurality of actions, receive an indication of a selection of a selectable element of the selectable elements, and implement an action to address the event.

### TECHNICAL FIELD

The present disclosure relates generally to generative artificial intelligence (AI), more specifically to proactive content generation of a generative AI model.

### BACKGROUND

Artificial intelligence (AI) models may be used to provide information to a user. More specifically, AI models may provide content that pertains to a user based on user information.

### SUMMARY

One embodiment relates to a provider computing system including at least one processing circuit having at least one processor coupled to at least one memory device. The at least one memory device can store instructions that, when executed by the at least one processor, cause the at least one processing circuit to detect, responsive to an occurrence of an event associated with an account of a user, initiation of a session to access the account by a user device of the user. The instructions can also cause the at least one processing circuit to detect, using a machine learning model stored in the at least one memory device, correlations between the event and one or more previous occurrences of one or more events similar to the event. The correlations can identify one or more factors that impacted the occurrence of the event. The instructions can also cause the at least one processing circuit to generate, using the machine learning model, based on the one or more factors, a plurality of actions to address the event. The instructions can also cause the at least one processing circuit to transmit one or more signals to cause the user device to display a user interface including selectable elements to indicate the plurality of actions. The instructions can also cause the at least one processing circuit to receive, from the user device, an indication of a selection of a selectable element of the selectable elements. The selectable element can be associated with an action of the plurality of actions. The instructions can also cause the at least one processing circuit to implement, responsive to receiving the indication, the action to address the event.

Another embodiment relates to a method. The method can include detecting, by a computing system, responsive to an occurrence of an event associated with an account of a user, initiation of a session to access the account by a user device of the user. The method can also include detecting, by the computing system using a machine learning model, correlations between the event and one or more previous occurrences of one or more events similar to the event. The correlations can identify one or more factors that impacted the occurrence of the event. The method can also include generating, by the computing system using the machine learning model, based on the one or more factors, a plurality of actions to address the event. The method can also include transmitting, by the computing system, one or more signals to cause the user device to display a user interface including selectable elements to indicate the plurality of actions. The method can also include receiving, by the computing system, from the user device, an indication of a selection of a selectable element of the selectable elements. The selectable element can be associated with an action of the plurality of actions. The method can also include implementing, by the computing system, responsive to receiving the indication, the action to address the event.

Still another embodiment relates to a non-transitory computer-readable storage media having instructions stored thereon that, when executed by at least one processor of a provider computing system, cause the provider computing system to perform operations including: detecting, responsive to an occurrence of an event associated with an account of a user, initiation of a session to access the account by a user device of the user; retrieving, responsive to detecting initiation of the session, information to detect correlations between the event and the one or more previous occurrences of the one or more events, retrieving the information to detect the correlations can include retrieving, from one or more publicly accessible databases, information describing one or more aspects of the event or the one or more events, or retrieving, by the computing system, from a database associated with a provider, information describing one or more actions previously implemented to address the one or more events; detecting, using a machine learning model stored in the at least one memory device, correlations between the event and one or more previous occurrences of one or more events similar to the event, the correlations can identify one or more factors that impacted the occurrence of the event; generating, using the machine learning model, based on the one or more factors, a plurality of actions to address the event; transmitting one or more signals to cause the user device to display a user interface including selectable elements to indicate the plurality of actions; receiving, from the user device, an indication of a selection of a selectable element of the selectable elements, the selectable element can be associated with an action of the plurality of actions; and implementing, responsive to receiving the indication, the action to address the event.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts a block diagram of a system to provide proactive content, according to an example embodiment.

FIG. 2 depicts a provider computing system included in the system illustrated in FIG. 1, according to an example embodiment.

FIG. 3 depicts an example user interface that may provide content associated with a user, according to an example embodiment.

FIG. 4 depicts an example user interface that may provide content associated with a user, according to an example embodiment.

FIG. 5 depicts an example user interface that may provide content associated with a user, according to an example embodiment.

FIG. 6 depicts an example user interface that may provide content associated with a user, according to an example embodiment.

FIG. 7 depicts a flow diagram of a method to provide proactive content to a user, according to an example embodiment.

FIG. 8 depicts a block diagram of a system for supervised learning, according to an example embodiment.

FIG. 9 depicts a block diagram of a simplified neural network model, according to an example embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein.

The systems, methods, computer-readable media, and apparatuses described herein relate to an artificial intelligence system, and particularly a generative artificial intelligence system, configured or structured to provide proactive content prior to receiving a prompt from a user.

According to various embodiments described herein, the systems, methods, and computer-readable media described herein relate to a technical solution of using a generative AI model to provide proactive content. The generative AI model may detect interactions of a user and provide content that pertains to the interactions. The generative AI model may provide content that addresses and/or assist the user with one or more aspects of an account. For example, the generative AI model may provide content that assists a user in understanding why a transaction was declined. As another example, the generative AI model may provide content that assists a user in creating a payment plan for their account.

The systems, methods, and computer-readable media described herein offer technical improvements to existing AI systems. For example, by providing content to a user, prior to the user requesting the content, the user's question may be addressed in an efficient manner. In this way, the user may log in to their account to address an event and the generative AI model may provide, without prompting from the user, content that addresses the event. By proactively providing content which addresses the event without prompting from a user, the generative AI model as described herein reduces bandwidth by limiting interactions between the generative AI model and a user. Further, the generative AI model may access user contextual information to enable customization and tailoring of responses to be specific to the user and to the user's particular contextual situation, thereby potentially improving the efficacy of the information provided by the AI system to the user. Additionally, the AI model may be trained to detect correlations between events and one or more previous events. For example, the AI model can be trained to detect that a first event is correlated to one or more second events. To continue this example, the AI model can be trained to extract information corresponding to the second events for use in evaluating the first event. These non-conventional operating characteristics may lead to more desirable AI system operation for users as well as improved resource utilization, by decreasing the number of interactions between the user and the generative AI model by providing content prior to the user asking for the content. These and other features and benefits are described more fully herein.

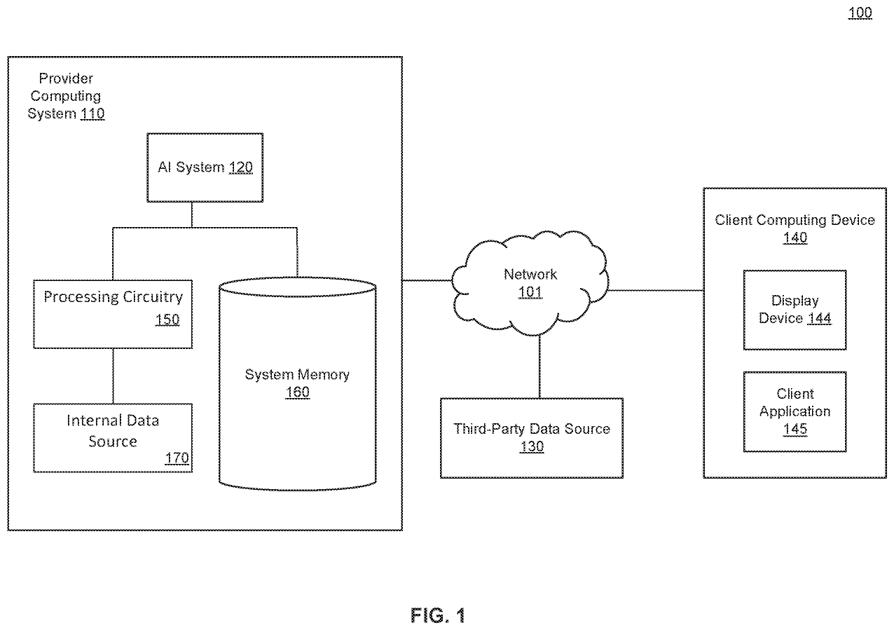

FIG. 1 depicts a block diagram of a system 100 to provide proactive content utilizing an artificial intelligence (AI) system, according to an example embodiment. As illustrated by way of example in FIG. 1, the system 100 can include at least a network 101, a provider computing system 110 having an AI system 120, a third-party data source 130, and a client computing device 140. The network 101 may communicably couple the components and/or systems to each other. As described herein, the provider computing system 110 may receive inputs (e.g., prompts, responses, information, data, credentials, selections) from a user via a user interface (e.g., a user interface of a display device 144) of the client computing device 140. The provider computing system 110 may query/retrieve/obtain information from one or more data sources (e.g., the third-party data source 130, an internal data source 170) associated with a user (e.g., transaction history, financial information, learning metrics, device interactions), to generate proactive content for the user. The proactive content may pertain to the user. For example, the proactive content may pertain to an account that the user has with a provider institution. The provider computing system 110 may construct and/or generate the proactive content using information that pertains to the user and/or an event that pertains to the user. For example, the provider computing system 110 may generate proactive content that pertains to a user that is creating a payment plan. As another example, the proactive content may include content which pertains to a payment plan of a user, an action related to a credit card transaction, content which pertains to opening an account, content which pertains to updating a list of authorized users for an account, or content which pertains to routine purchases or expenses.

The network 101 can include any type or form of one or more networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The provider computing system 110 is owned by, associated with, or otherwise operated by a provider institution (e.g., a bank or other financial institution) that maintains one or more accounts held by various customers (e.g., the customer/user associated with the client computing device 140), such as demand deposit accounts, credit card accounts, receivables accounts, and so on. In some instances, the provider computing system 110 may include one or more servers, each with one or more processing circuits having one or more processors configured to execute instructions stored in one or more memory devices to send and receive data stored in the one or more memory devices and perform other operations to implement the features, methods, and operations described herein. In the example shown, the provider computing system 110 includes an AI system 120, a processing circuitry 150, a system memory 160, and an internal data source 170.

The AI system 120 may include one or more servers, databases, or cloud computing environments that may execute one or more generative AI models. The generative AI models may include, but are not limited to, large language models (LLMs), which can be trained to generate human-like text, speech, images, and/or components of graphical user interfaces. The generative AI models may be structured using a deep learning architecture that includes a multitude of interconnected layers, including attention mechanisms, self-attention layers, and transformer blocks. The generative AI models can be trained on large datasets to assimilate patterns, structures, and relationships within the data. The trained generative AI models can be trained to generate outputs that resemble or closely resemble the characteristics of a user and/or an event that pertains to the user. The generative AI models may be fine-tuned to generate specific output data, including data that is compatible with various database architectures or provider computing systems. The generative AI models can be trained via optimization of a large number of parameters, in which the generative AI models learn to minimize the error between its predictions and the actual data points, resulting in highly accurate and coherent generative capabilities.

The AI system 120 may include at one or more Machine Learning models or Artificial Intelligence models. For example, the AI system 120 may include regression trees, deep neural networks, supervised learning model, unsupervised learning models, nearest neighbor, Generative Artificial Intelligence, Transformers, or many other types of models. The AI system 120 may be trained to detect correlations between events that impact users accounts. For example, the AI system 120 may be trained to detect correlations between declined transaction requests. As another example, the AI system 120 may be trained to detect correlations between opening accounts. The AI system 120 may be tested and/or processed to determine that the AI system 120 is ready to be implemented. For example, the AI system 120 may be found repetitive prompts with similar information. To continue this example, the AI system 120 may be ready for implementation responsive to the AI system 120 providing repetitive responses to similar or identical prompts.

The processing circuitry 150 includes one or more processing circuits including one or more processors coupled to one or more memory devices. The processing circuitry 150 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuitry 150 can include a memory operable to store or storing one or more instructions for operating components of the processing circuitry 150 and operating components operably coupled to the processing circuitry 150. For example, the one or more instructions can include one or more of firmware, software, hardware, operating systems, embedded operating systems. The memory may include one or more devices (e.g., RAM, ROM, Flash memory, hard disk storage) for storing data and/or computer code for completing and/or facilitating the various processes described herein. The memory may include non-transient volatile memory, non-volatile memory, and non-transitory computer storage media, database components, object code components, script components, or any other type of information structure for supporting the various activities and information structures described herein. The processing circuitry 150 or the provider computing system 110 generally can include one or more communication bus controllers to effect communication between the processing circuitry 150 and the other elements of the provider computing system 110.

According to some exemplary embodiments, the provider computing system 110 may comprise an interface controller. The interface controller may be a controller structured or configured to link the provider computing system 110 with one or more of the network 101, the client computing device 140, and the third-party data source 130, by one or more communication interfaces. A communication interface can include, for example, an application programming interface (“API”) compatible with a particular component of the provider computing system 110, the client computing device 140, or the third-party data source 130. The communication interface can provide a particular communication protocol compatible with a particular component of the provider computing system 110 and a particular component of the client computing device 140 or the third-party data source 130. The interface controller can be compatible with particular content objects and can be compatible with particular content delivery systems corresponding to particular content objects, structures of data, types of data, or any combination thereof. For example, the interface controller can be compatible with transmission of video content, audio content, image data, or any combination thereof.

The system memory 160 can store data associated with the provider computing system 110. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, or a NAND memory device. The system memory 160 can include one or more addressable memory regions disposed on one or more physical memory arrays. A physical memory array can include a NAND gate array disposed on, for example, at least one of a particular semiconductor device, integrated circuit device, and printed circuit board device.

The third-party data source 130 or computing system may be associated with a third-party (e.g., owned by, operated by, managed by, and/or otherwise associated with the third-party). The third-party may be an entity that is a third-party relative to the provider entity/institution. While only one third-party data source is depicted, it should be appreciated that multiple third-parties can be included in the system 100 and coupled, via the network 101, to the provider computing system 110. The third-party computing system 130 can be a cloud system, a server, a distributed remote system, or any combination thereof. As another example, the third-party computing system 130 can include an operating system configured to execute a virtual environment. The operating system can include hardware control instructions and program execution instructions. The operating system can include a high-level operating system, a server operating system, an embedded operating system, or a boot loader.

The client computing device 140 is owned, operated, controlled, managed, and/or otherwise associated with a user. In this example, the user is a customer of the provider institution. In some embodiments, the client computing device 140 may be or may comprise, for example, a desktop or laptop computer (e.g., a tablet computer), a smartphone, a wearable device (e.g., a smartwatch), a personal digital assistant, and/or any other suitable computing device. In the example shown, the client computing device 140 is structured as a mobile computing device, namely a smartphone. The client computing device 140 can communicate with the provider computing system 110 by the network 101 via one or more communication protocols therebetween.

The client computing device 140 can include one or more I/O devices, a network interface circuit, at least one processing circuit, and various other components and/or systems. The client computing device 140 is shown to include an I/O device as a display device 144. While the term “I/O” is used, it should be understood that the I/O devices may be input-only devices, output-only devices, and/or a combination of input and output devices. In some instances, the I/O devices include various devices that provide perceptible outputs (such as display devices with display screens and/or light sources for visually perceptible elements, an audio speaker for audible elements, and haptics or vibration devices for perceptible signaling via touch, etc.), that capture ambient sights and sounds (such as digital cameras, microphones, etc.), and/or that allow the user to provide inputs (such as a touchscreen display, stylus, keyboard, force sensor for sensing pressure on a display screen. The I/O devices can include a display configured to present a user interface or graphical user interface. The I/O devices can output at least one or more user interface presentations and control affordances. The I/O devices can generate any physical phenomena detectable by human senses, including, but not limited to, one or more visual outputs, audio outputs, haptic outputs, or any combination thereof.

The display device 144 can display at least one or more user or graphical user interfaces. The display device 144 can include, for example, a liquid crystal display (LCD), a light-emitting diode (LED) display, an organic light-emitting diode (OLED) display, or the like. The display device 144 can receive, for example, capacitive or resistive touch input.

The client computing device 140 is also shown to include a client application 145. The client application 145 may be a financial institution banking application provided by and/or at least partly supported by the provider computing system 110. In some instances, the client application 145 is coupled to the provider computing system 110 and may enable account management regarding one or more accounts held at the provider institution associated with the provider computing system 110 (e.g., funds transfers, bill payment). In some instances, the client application 145 provided by the provider computing system 110 incorporates various functionality provided by or otherwise enabled by the provider computing system 110 (e.g., initiating and/or approving transfers) using one or more application programming interfaces (APIs) and/or software development kits (SDKs) provided by the provider computing system 110. Accordingly, the client application 145 is structured to provide the user with access to various services offered by the provider institution.

In some embodiments, the client application 145 is hard coded into the memory of the client computing device 140. Thus, the client application 145 may be executed or run by one or more processors of the client computing device 140. In some embodiments, the client application 145 is a web-based interface application, where the user logs into or otherwise accesses the web-based interface before usage. In such embodiments, the application may be supported by a separate computing system comprising one or more servers, processors, network interface circuits, or the like (e.g., the provider computing system 110), that transmit the application data for use to the client computing device 140.

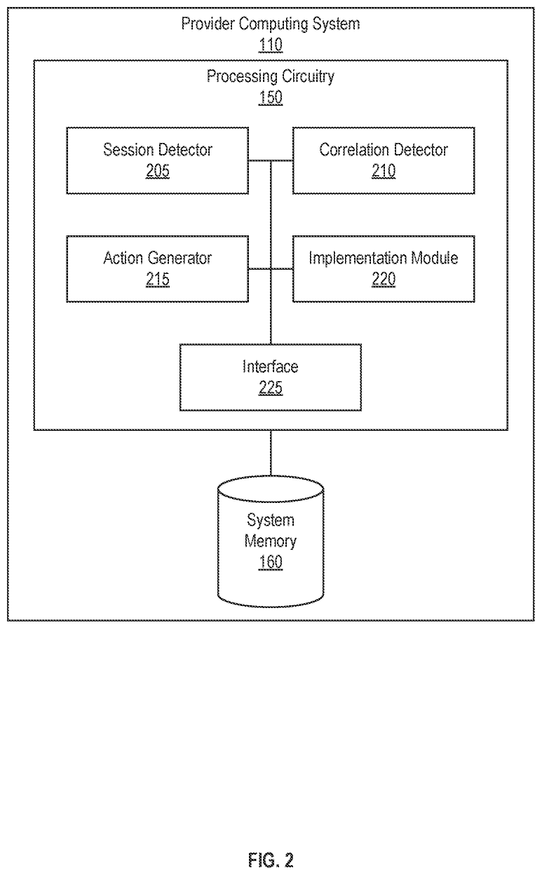

FIG. 2 depicts, in greater detail, the provider computing system 110 of the system 100 of FIG. 1, according to an example embodiment. In some embodiments, the processing circuitry 150 may include a session detector 205, a correlation detector 210, an action generator 215, and implementation module 220, and an interface 225. In some embodiments, the various components and/or devices of the processing circuitry 150 may be stored in the system memory 160. For example, the session detector 205 may be stored in the system memory 160 as program code, instructions, firmware, and/or executable code. In some embodiments, the system memory 160 may store instructions that cause the processing circuitry 150 to perform the various processes and/or steps described herein. In some embodiments, the system memory 160 may store the various types of information described herein. For example, the system memory 160 may store transaction information that pertains to one or more users.

In some embodiments, the interface 225 may communicate with, interface with, and/or otherwise interact with the various systems, devices, and/or components of the system 100. For example, the interface 225 may communicate with the client computing device 140. In some embodiments, the interface 225 may include at least one communication device. For example, the interface 225 may include a transceiver. In some embodiments, the interface 225 may include at least one of the interface controller, the communication interface, and/or the various communication devices described herein.

In some embodiments, the session detector 205 may be structured or configured to analyze, parse, inspect, or otherwise process data received from at least one of the third-party data source 130, the client computing device 140 (e.g., data received as an input from a user via a user interface of the display device 144), and the internal data source 170. The data processed by the session detector 205 may include information associated with the user (e.g., transaction history, financial information, academic performance).

In some embodiments, the session detector 205 may detect initiation of one or more sessions. For example, the session detector 205 may detect that the client computing device 140 has initiated, via the client application 145, a mobile wallet session to access information associated with an account of a user. The session detector 205 may detect initiation of the sessions responsive to an occurrence of one or more events. For example, the session detector 205 may detect initiation of a first session responsive to an occurrence of a first event. In some embodiments, the sessions may be initiated automatically or responsive to one or more actions of a user. For example, the sessions may be initiated responsive to a user logging into their online banking account. In some embodiments, the session detector 205 may detect initiation of one or more sessions responsive to an occurrence of an event that is associated with an account of a user. For example, the session detector 205 may detect initiation of a session responsive to a transaction being declined for a user. To continue this example, the user may initiate the session by logging in a mobile application. Furthermore, the session detector 205 may detect that the user logged into their account. In some embodiments, the session detector 205 may communicate with the correlation detector 210 responsive to detecting initiation of one or more sessions.

In some embodiments, the events may include at least one of event may include at least one of a declined transaction request, an account adjustment request, a transaction alert a payment date a threshold alert. In some embodiments, the user may be notified of an event (e.g., an upcoming payment date) and the event may result in the user initiating a session. The session detector 205 may also detect and/or receive indications of the occurrences of the events. For example, the session detector 205 may detect when a transaction request has been declined. As another example, the session detector 205 may receive, via the interface 225, an indication of an event from the third-party data source 130.

In some embodiments, the correlation detector 210 may detect correlations between the events and one or more previous events. For example, the correlation detector 210 may detect correlations between a user attempting to set up an autopay for an account (e.g., an event) and one or more previous instances of user setting up autopay. In some embodiments, the correlation detector 210 may implement and/or utilize the AI system 120 to detect correlations. For example, the AI system 120 may be trained to detect correlations between events. In some embodiments, the AI system 120 may be implemented as a random forest that is trained to detect correlations. In some embodiments, the AI system 120 may detect correlations between events based on similarities between the events. For example, the events may include similar circumstances and the AI system 120 may detect correlations based on the circumstances. Stated otherwise, the AI system 120 may detect correlations based on similarities between events.

In some embodiments, the AI system 120 may include at least one of a Large Language Model, a generative pre-trained transformer, or a generative artificial intelligence model. For example, the AI system 120 may include and/or be implemented as a generative AI model. In some embodiments, the correlation detector 210 may detect correlations by generating information that was absent from data used to train the AI system 120. For example, the AI system 120 may learn to generate correlations between events instead of just pulling correlations that already exist in memory.

In some embodiments, the correlations between events may identify one or more factors that impacted occurrences of the events. As one example, an event may be a declined transaction request. In this example, the one or more factors that impacted the occurrence of the event may include, for instance, a low balance, an account balance that exceeds a credit limit, a transaction request limit, and/or potential fraud detection. In some embodiments, the correlation detector 210 may use the factors to determine and/or identify reasons for the event. For example, the correlation detector 210 may determine that a transaction request was declined (e.g., an event) based on an account balance being less than a predetermined level (e.g., a factor). In some embodiments, the correlation detector 210 may provide the correlations and/or the factors to the action generator 215.

In some embodiments, the action generator 215 may generate one or more actions to address the events. For example, the action generator 215 may generate actions that, when taken and/or executed, resolve and/or address the event. In some embodiments, the actions may include actions that can be implemented by the provider computing system 110. For example, a first action may be to request a credit limit increase and the provider computing system 110 may submit the request. In some embodiments, the actions may be actions that include receiving information from a user. For example, the actions may include receiving payment information to use for automatic payments in the account.

In some embodiments, the action generator 215 may implement and/or utilize the AI system 120 to generate the actions. For example, the action generator 215 may access the AI system 120 to generate actions. In some embodiments, the action generator 215 may generate the actions based on the factors determined by the correlation detector 210. For example, the AI system 120 may be trained to generate actions based on factors that impacted the occurrence of the events. Stated otherwise, the AI system 120 may learn to identify actions that address factors that lead to the occurrence of the event.

In some embodiments, the AI system 120 may be trained, using labeled datasets, to generate the actions. For example, the labeled datasets may include previous actions that were taken to address previous events. The AI system 120 may be trained to generate actions for subsequent events based on the events or actions included in the labeled datasets. For example, the labeled datasets may include actions that were taken to address a stolen credit card. To continue this example, the AI system 120 may be trained to generate subsequent actions that correspond to stolen credit cards based on the actions included in the labeled datasets.

In some embodiments, the interface 225 may transmit one or more signals. For example, the interface 225 may transmit signals to the client computing device 140. In some embodiments, the interface 225 may transmit signals to cause the client computing device 140 to display a user interface. For example, the interface 225 may transmit signals that cause the display device 144 to display a user interface. In some embodiments, the user interfaces may include at least one element (e.g., button, icon, images, graphics) and a user may interact with the elements. The elements may include selectable elements that indicate the actions generated by the action generator 215. For example, the user interface may include check boxes and/or selectable icons that indicate the actions.

The interface 225 may receive one or more indications. For example, the interface 225 may receive indications from the client computing device 140. In some embodiments, the interface 225 may receive an indication of a selection of a selectable element. For example, the interface 225 may receive an indication that a user has selected an element that is included in the user interface. Stated otherwise, a user may select an icon in the user interface and the interface 225 may receive an indication of the selection. In some embodiments, the selected element may be associated with one or more actions. For example, the selected element may be associated with an action generated by the action generator 215. In some embodiments, the interface 225 may communicate the indication to the implementation module 220.

In some embodiments, the implementation module 220 may implement one or more actions. For example, the implementation module 220 may implement the actions generated by the action generator 215. In some embodiments, the implementation module 220 may implement the actions by performing one or more operations. For example, the a given action may include requesting a credit limit increase and the implementation module 220 may submit the request. As another example, the implementation module 220 may retrieve user information to include one or more forms.

In some embodiments, the correlation detector 210 may retrieve information to detect the correlations between the events. For example, the correlation detector 210 may retrieve information from at least one of the internal data source 170, the system memory 160, the third-party data source 130, and/or the client computing device 140. In some embodiments, the correlation detector 210 may retrieve the information by querying and/or searching one or more databases. For example, the correlation detector 210 may retrieve the information by querying the internal data source 170.

In some embodiments, the correlation detector 210 may retrieve the information by retrieving information that describes one or more aspects of the events. The correlation detector 210 may retrieve the information from one or more publicly accessible databases. In some embodiments, the correlation detector 210 may retrieve the information by retrieving information that described one or more actions previously implemented to address one or more events. In some embodiments, the correlation detector 210 may detect the correlation using the information retrieved from the publicly accessible databases and/or a provider database.

In some embodiments, the session may include an authenticated session between one or more devices. For example, the session may include an authenticated session between a user and an account representative. To continue this example, the authenticated session may include communication between a first client computing device 140 and a second client computing device 140. In some embodiments, the provider computing system 110 may provide information to at least one of the first client computing device 140 and/or the second client computing device 140. For example, the provider computing system 110 may transmit signals that cause the computing devices to display a user interface that includes the actions generated by the action generator 215.

In some embodiments, the first client computing device 140 may be associated with a user who has one or more accounts with a provider and the second client computing device 140 may be associated with an account representative for the provider. The provider computing system 110 may transmit signals that cause the second client computing device 140 to display one or more user interfaces. In some embodiments, the user interfaces may include the actions generated by the action generator 215. The user interfaces, displayed by the second client computing device 140, may also include information that is not provided and/or presented to a user (e.g., the first client computing device 140). For example, the user interface may include information that is proprietary and/or confidential. As another example, the user interface may include information, generated by the provided computing system 110, but that does not pertain to one or more aspects of the user's account.

In some embodiments, the interface 225 may receive one or more indications from the second client computing device 140. For example, the interface 225 may receive information that was provided to the second client computing device 140. In some embodiments, the interface 225 may receive an indication of a request to provide a portion of information that previously was absent from a user interface displayed by the first client computing device 140. For example, the request may be a request to receive information that was provided to the second client computing device 140.

In some embodiments, the interface 225 may provide the portion of the information to the first client computing device 140. The interface 225 may provide the information by transmitting one or more signals that causes the first client computing device 140 to display and/or update a user interface. In some embodiments, the provider computing system 110 may provide information based on a credential of the user. For example, the provider computing system 110 may provide information that is accessible with a given credential and/or may decline a request for information that is associated with a different credential.

In some embodiments, the session detector 205 may monitor and/or analyze activity of the client computing devices 140. For example, the session detector 205 may monitor activity of a first client computing device 140 to determine initiation of subsequent sessions. In some embodiments, the session detector 205 may determine an amount of time that has elapsed between a first session and a second session. For example, the session detector 205 may determine that 1 week has elapsed between a first session and a second session. As another example, the session detector 205 may determine that 2 days has elapsed. In some embodiments, the session detector 205 may communicate with the interface 225 to cause the interface 225 to transmit one or more signals to the client computing device 140. For example, the session detector 205 may provide, to the interface 225, an action that was previous implemented to address a first session and the interface 225 may transmit one or more signals to cause the client computing device 140 to display a user interface that includes the action. As another example, the session detector 205 may determine that an amount of time elapsed between a first session and a second session is less than a predetermined threshold. To continue this example, the session detector 205 may transmit, via the interface 225, signals to cause the client computing device 140 to display an action that was implemented to address an event associated with the first session.

In some embodiments, the session detector 205 may retrieve information associated with one or more users. For example, the session detector 205 may retrieve account information. As another example, the session detector 205 may retrieve contact information for one or more users. In some embodiments, the session detector 205 may retrieve the information responsive to initiation of one or more sessions. For example, the session detector 205 may retrieve information associated with a first user responsive to the first user initiating, via the client computing device 140, a mobile wallet session.

In some embodiments, the session detector 205 may identify one or more actions that were skipped and/or delayed based on the retrieve information. For example, the session detector 205 may determine that the user failed to set an autopay schedule upon establishing/creating an account. As another example, the session detector 205 may determine that the user has not yet provided secondary contact information.

In some embodiments, the correlation detector 210 may predict one or more occurrences of events. For example, the correlation detector 210 may predict occurrences of events that may occur as a result of actions that were previously skipped and/or delayed. In some embodiments, the occurrences may occur as a result of missing or incomplete information. For example, a missed payment may occur as a result of an account now having autopay setup. As another example, a statement may not be emailed to a device responsive to account information missing an email address. In some embodiments, the AI system 120 may predict occurrences of events based on one or more simulations. For example, the AI system 120 may perform simulations, based on account information, to predict occurrences that may occur with respect to a corresponding account. As another example, the AI system 120 may monitor payment dates for one or more accounts. To continue this example, the AI system 120 may predict missed payments (e.g., occurrences of events) based on one or more accounts missing either payment information or autopay schedules.

In some embodiments, the correlation detector 210 may provide, to the interface 225, the actions that were previously omitted, skipped, and/or delayed and the interface 225 may transmit signals to cause the client computing device 140 to display, via a user interface, the actions. In some embodiments, the implementation module 220 may implement one or more of the omitted, skipped, and/or delayed actions to prevent an occurrence of a correlated event. For example, the implementation module 220 may prompt the client computing device 140 for contact information and the implementation module 220 may provide, to the internal data source 170 the contact information. As another example, the implementation module 220 may assist a user with creating and/or updating a payment schedule to prevent a missed payment (e.g., an occurrence of an event). In some embodiments, the implementation module 220 may assist the users by creating a chat window and then subsequently prompting a user for information. As the implementation module 220 receives input from the user, the implementation module 220 may update their accounts.

As described herein, the provider computing system 110 may generate, provide, present, and/or otherwise display one or more user interfaces. For example, the provider computing system 110 may transmit, to the client computing device 140, signals that cause the client computing device 140 to display one or more user interfaces. In some embodiments, the user interfaces may display and/or include the various types of information described herein. For example, the user interfaces may display the actions generated by the action generator 215. As another example, the user interfaces may display information that is provided by a user.

In some embodiments, the various user interfaces described herein may be provided and/or presented as one or more user interfaces. For example, the user interfaces may be provided as single user interface and a user may scroll, browse, and/or otherwise scan the user interface. As another example, the user interfaces may be provided as subsequent windows, pages, screens, and/or boxes within a user interfaces. The user interfaces may also be provided as pop-windows and/or overlays. In some embodiments, the various systems, devices, and/or components described herein may generate, present, provide, and/or otherwise display at least one of the user interfaces described herein.

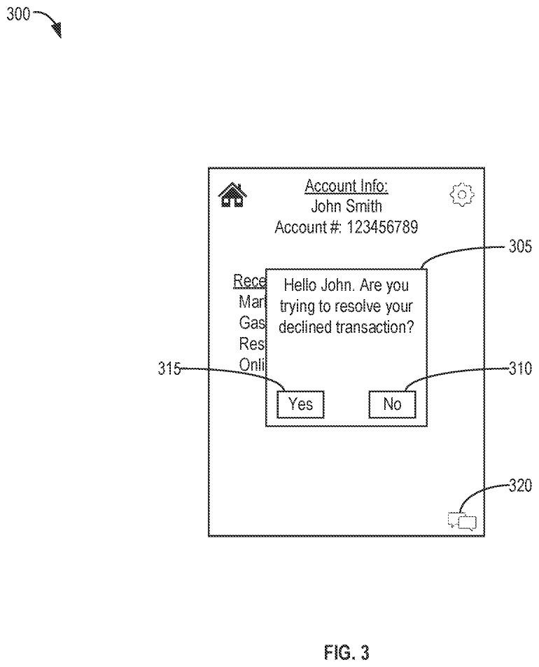

FIG. 3 depicts a user interface 300, according to some embodiments. In some embodiments, the user interface 300 may be displayed via the display device 144. For example, the display device 144 may display the user interface 300 responsive to receiving one or more signals from the interface 225. As another example, the client application 145 may cause the display device 144 to display the user interface. In some embodiments, the user interface 300 may be displayed responsive to the session detector 205 detecting initiation of a session. For example, the user interface 300 may be displayed responsive to the session detector 205 detecting that a user has accessed a mobile banking account. As another example, the user interface 300 may be displayed responsive to the session detector 205 detecting that a user has initiated a session with an account representative.

In some embodiments, the user interface 300 may include a prompt 305 and/or a text box 305. The prompt 305 may include a message that include proactive content generated by the provider computing system 110. For example, as shown in FIG. 3, the prompt 305 is asking a user if they are initiating a session to resolve a decline transaction. In some embodiments, the message included in the prompt 305 is generated by the provider computing system 110. For example, the provider computing system 110 may detect that a transaction request was declined. To continue this example, the provider computing system 110 may detect initiation of a session. In some embodiments, the provider computing system 110 may predict that the user initiated the session to address the event. The provider computing system 110 may provide content to address the event without the user asking for the information (e.g., proactive content).

In some embodiments, the user interface 300 may include icons 310 and 315. A user may select the icon 310 to indicate that they did not initiate the session to address the declined transaction. The user may select the icon 315 to indicate that they did initiate the session to address the declined transaction. In some embodiments, selection of the icon 310 and/or the icon 315 may cause the user interface 300 to be updated, modified, adjusted, and/or replaced. In some embodiments, the interface 225 may receive at least one of the various indications described herein responsive to a user selecting at least one of the icon 310 and/or the icon 315. The user interface 300 may also include an icon 320. The user may select the icon 320 to initiate a session with an account representative. In some embodiments, a user selecting the icon 320 may initiated at least one of the various authenticated sessions described herein.

In some embodiments, the prompt 305 may include a window and/or text box to receive information from a user. For example, the prompt 305 may include a window to receive information entered by the user. In some embodiments, the prompt 305 may also include a prompt asking the user to provide subsequent information. For example, the prompt 305 may ask the user to provide information that explains one or more aspects of a given event. In some embodiments, the action generator 215 may generate one or more actions based on the subsequent information provided by the user. For example, the user may provide an indication that they credit card was stolen and the action generator 215 may generate actions that address the stolen credit card.

In some embodiments, the prompt 305 may prompt the user to provide authentication information. For example, the prompt 305 may prompt the user to provide log in information. As another example, the prompt 305 may prompt the user to provide a credential (e.g., a PIN, a passcode, biometrics). In some embodiments, the user interface 300 may receive the credential from the user. For example, the user may enter and/or provider a PIN into the user interface 300. In some embodiments, the action generator 215 may generate one or more actions based on the credential received from the user. For example, the provided credential may indicate and/or identify the user as the primary account holder and the action generator 215 may generate actions that correspond to a primary account holder. As another example, the provided credential may indicate that the user is not authorized to modify account settings and the action generator 215 may generate actions that do not include modifying account setting.

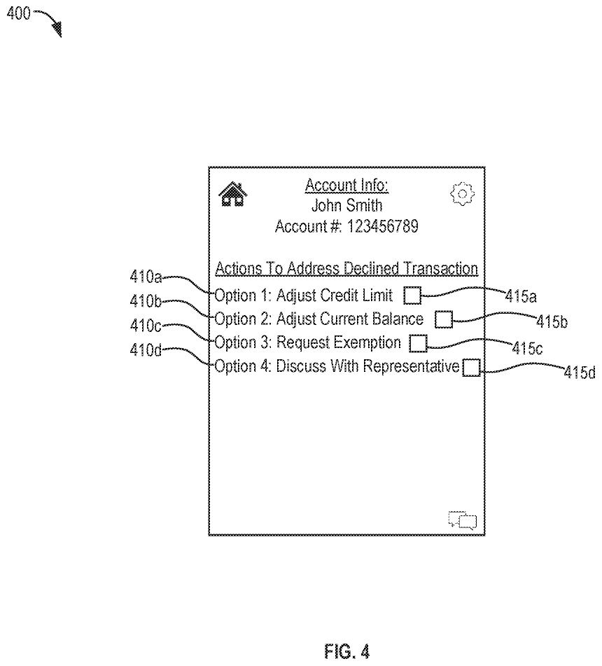

FIG. 4 depicts a user interface 400, according to some embodiments. In some embodiments, the user interface 400 may be displayed via the display device 144. For example, the display device 144 may display the user interface 400 responsive to receiving one or more signals from the interface 225. In some embodiments, the user interface 400 may displayed responsive to a user selecting at least one of the icon 310 and/or the icon 315. For example, the user interface 400 may displayed responsive to the provider computing system 110 receiving an indication of a selection. In some embodiments, the user interface 400 may include one or more actions 410. For example, the user interface 400 may include actions 410 that address the event that prompted a user to initiate a session. In some embodiments, the actions 410 may be generated by the action generator 215. For example, the action generator 215 may generate the actions 410 responsive to a user selecting one or more icons.

In some embodiments, the user interface 400 may include one or more elements 415. The elements 415 may correspond to and/or pertain to the actions 410. For example, a user may select element 415a to accept and/or implement action 410a. As another example, a user may select element 415b to accept and/or implement action 410b. In some embodiments, the implementation module 220 may implement actions that correspond to one or more selected elements. For example, the implementation module 220 may implement action 410d responsive to a user selecting element 415d.

In some embodiments, the user interface 400 may include one or more prompts asking the user to accept implementation of one or more actions. For example, the user interface 400 may include a prompt asking the user to accept subsequent implementation of one or more actions. As another example, the user interface 400 may include a prompt asking the user to authorize the provider computing system 110 to perform subsequent actions to provider future occurrences of a similar event.

In some embodiments, the provider computing system 110 may receive one or more indications from the client computing device 140. The indications may indicate that the user accepted the prompt to allow for subsequent implementation of one or more actions. In some embodiments, the provider computing system 110 may update an account associated with the user to reflect acceptance of subsequent implementation. For example, the provider computing system 110 may update an account that is stored in the internal data source 170.

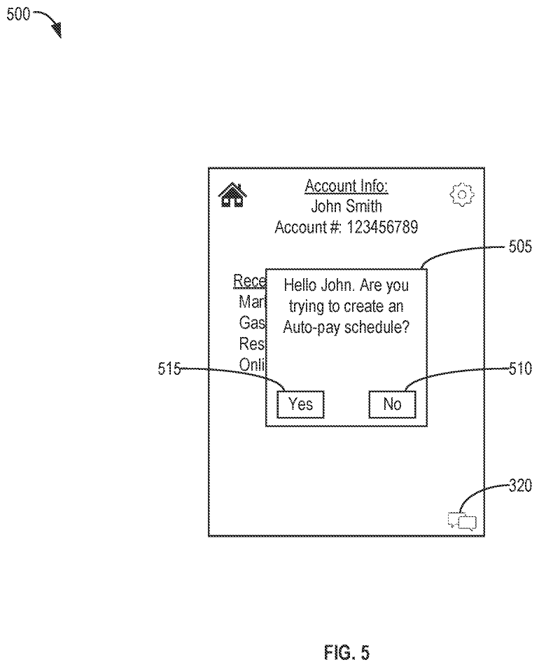

FIG. 5 depicts a user interface 500, according to some embodiments. In some embodiments, the user interface 500 may be displayed via the display device 144. For example, the display device 144 may display the user interface 500 responsive to receiving one or more signals from the interface 225. In some embodiments, the user interface 500 may include and/or present information similar to that of the user interface 300. In some embodiments, the user interface 500 may include prompt 505. A user may select at least one of icon 510 and/or 515 to accept and/or decline the prompt 505. In some embodiments, the user interface 500 may be modified, adjusted, changed, updated, and/or replaced responsive to selection of the icon 510 and/or the icon 515.

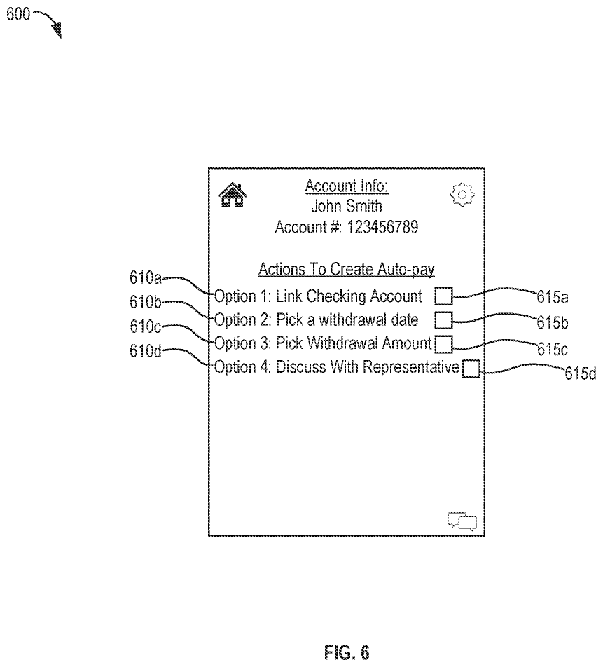

FIG. 6 depicts a user interface 600, according to some embodiments. In some embodiments, the user interface 600 may be displayed via the display device 144. For example, the display device 144 may display the user interface 600 responsive to receiving one or more signals from the interface 225. In some embodiments, the user interface 600 may be generated, displayed, and/or otherwise presented responsive to a user selecting the icon 515. In some embodiments, the user interface 600 may include one or more actions 610 to address the event indicated in the prompt 505. For example, the user interface 600 may include actions that assist a user with creating an auto-pay schedule.

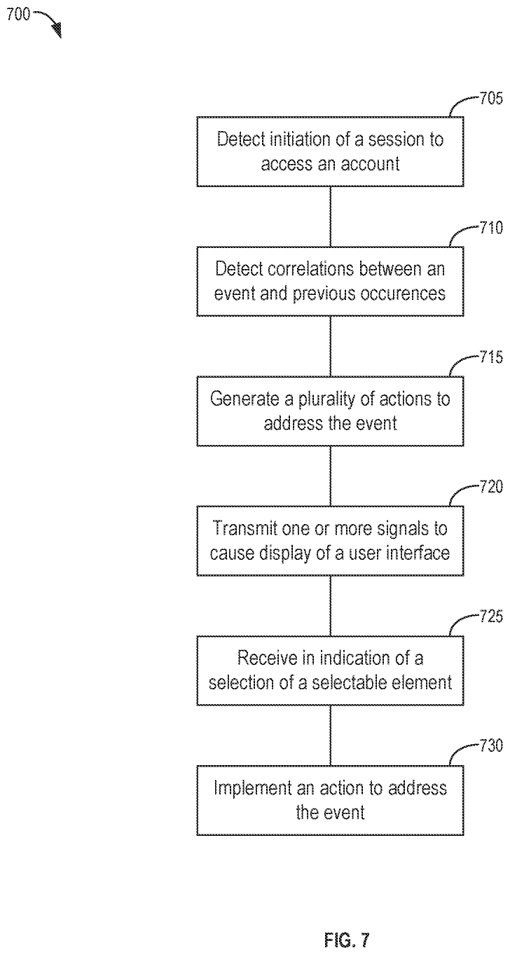

FIG. 7 depicts a flow diagram of a method 700 to provide proactive content to a user, according to an example embodiment. Various components and/or systems of the provider computing system 110 can perform the method 700. Via the method 700, the provider computing system 110 may provide proactive content to one or more users. For example, the provider computing system 110 may transmit one or more signals to cause the client computing device 140 to display one or more user interfaces that include proactive content generated by the provider computing system 110.

In step 705, initiation of a session to access an account may be detected, according to some embodiments. For example, the session detector 205 may detect that a user has initiated, via the client computing device 140, a mobile wallet session. In some embodiments, the mobile wallet session may be initiated responsive to one or more events. For example, the mobile wallet session may be initiated responsive to a declined transaction request. As another example, the mobile wallet session may be initiated responsive to a user creating and/or opening an account. In some embodiments, the session detector 205 may communicate with the correlation detector 210 responsive to the session detector 205 detecting the initiation of the session in step 705.

In step 710, correlations between an event and previous occurrences may be detected, according to some embodiments. For example, the correlation detector 210 may detect correlations between the event in step 705 and one or more previous occurrences of similar events. For example, the event in step 705 may be a missed payment and the correlation detector 210 may detect correlations between the missed payment and/or more previous missed payments. In some embodiments, the correlations may include and/or identify one or more factors that caused and/or pertain to the events. For example, missing payment information may cause a missed payment.

In step 715, one or more actions to address the event may be generated, according to some embodiments. For example, the action generator 215 may generate one or more actions to address the event from step 705. In some embodiments, the action generator 215 may implement and/or utilize the AI system 120 to generate the actions. For example, the action generator 215 may provide the correlations from step 710 to the AI system 120 and the AI system 120 may output the actions.

In step 720, one or more signals may be transmitted to cause display of a user interface, according to some embodiments. For example, the interface 225 may transmit one or more signals to the client computing device 140. To continue this example, the interface 225 transmitting the signals may cause the client computing device 140 to display one or more user interfaces. For example, the interface 225 may transmit one or more signals to cause the client computing device 140 to display the user interface 300.

In step 725, an indication of a selection of a selectable element may be received, according to some embodiments. For example, the interface 225 may receive one or more indications from the client computing device 140. In some embodiments, the interface 225 may receive the indications responsive to a user selecting at least one of the icons described herein. For example, the interface 225 may receive the indication of a selection of a selectable element responsive to a user selecting the icon 515. In some embodiments, the selection of the selectable element may indicate and/or be associated with one or more actions. For example, the selection of the selectable element may include a user selecting the element 415a.

In step 730, an action to address the event may be implemented. For example, the implementation module 220 may implement one or more actions. In some embodiments, the implementation module 220 may implement actions responsive to receiving the indication of the selection of the selectable element in step 730. For example, in step 725 the interface 225 may receive indication that the element 415b was selected and the implementation module 220 may implement one or more actions that correspond to element 415b.

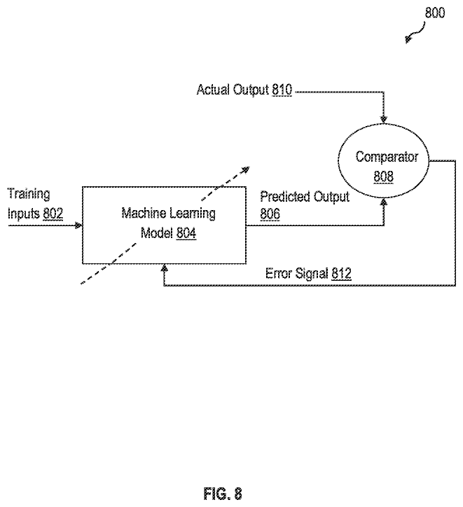

Referring to FIG. 8, a block diagram of an example system 800 using supervised learning, is shown. Supervised learning is a method of training a machine learning model given input-output pairs. An input-output pair is an input with an associated known output (e.g., an expected output).

Machine learning model 804 may be trained on known input-output pairs such that the machine learning model 804 can learn how to predict known outputs given known inputs. Once the machine learning model 804 has learned how to predict known input-output pairs, the machine learning model 804 can operate on unknown inputs to predict an output.

The machine learning model 804 may be trained based on general data and/or granular data (e.g., data based on a specific user 832) such that the machine learning model 804 may be trained specific to a particular user 832.

Training inputs 802 and actual outputs 810 may be provided to the machine learning model 804. Training inputs 802 may include labeled datasets that correspond to events and actions taken to address the events. The training inputs 802 can also include prompts to provide to one or more users.

The inputs 802 and actual outputs 810 may be received from the internal data source 170. The inputs 802 and the actual outputs 810 may be received from of the various data repositories described herein. For example, the inputs 802 and the outputs 810 may be received from the third-party data source 130. Thus, the machine learning model 804 may be trained to predict at least one of events, actions, or sessions based on the training inputs 802 and actual outputs 810 used to train the machine learning model 804.

The system 800 may include one or more machine learning models 804. In an embodiment, a first machine learning model 804 may be trained to predict data for one or more events. For example, the first machine learning model 804 may use the training inputs 802 to predict outputs 806, by applying the current state of the first machine learning model 804 to the training inputs 802. The comparator 808 may compare the predicted outputs 806 to actual outputs 810 to determine an amount of error or differences. For example, the predicted event (e.g., predicted output 806) may be compared to the actual event (e.g., actual output 810).

In other embodiments, a second machine learning model 804 may be trained to make one or more recommendations to the user 832 based on the predicted output from the first machine learning model 804. For example, the second machine learning model 804 may use the training inputs 802 to predict outputs 806 by applying the current state of the second machine learning model 804 to the training inputs 802. The comparator 808 may compare the predicted outputs 806 to actual outputs 810 to determine an amount of error or differences.

In some embodiments, a single machine leaning model 804 may be trained to make one or more recommendations to the user 832 based on current user 832 data received from enterprise resources 828. That is, a single machine leaning model may be trained using the training inputs to predict outputs 806 by applying the current state of the machine learning model 804 to the training inputs 802. The comparator 808 may compare the predicted outputs 806 to actual outputs 810 to determine an amount of error or differences. The actual outputs 810 may be determined based on historic data associated with the recommendation to the user 832.

During training, the error (represented by error signal 812) determined by the comparator 808 may be used to adjust the weights in the machine learning model 804 such that the machine learning model 804 changes (or learns) over time. The machine learning model 804 may be trained using a backpropagation algorithm, for instance. The backpropagation algorithm operates by propagating the error signal 812. The error signal 812 may be calculated each iteration (e.g., each pair of training inputs 802 and associated actual outputs 810), batch and/or epoch, and propagated through the algorithmic weights in the machine learning model 804 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 804 may be tuned to reduce the amount of error, thereby minimizing the differences between (or otherwise converging) the predicted output 806 and the actual output 810. The machine learning model 804 may be trained until the error determined at the comparator 808 is within a certain threshold (or a threshold number of batches, epochs, or iterations have been reached). The trained machine learning model 804 and associated weighting coefficients may subsequently be stored in memory 160 or other data repository (e.g., a database) such that the machine learning model 804 may be employed on unknown data (e.g., not training inputs 802). Once trained and validated, the machine learning model 804 may be employed during a testing (or an inference phase). During testing, the machine learning model 804 may ingest unknown data to predict future data (e.g., actions, events, sessions, and the like).

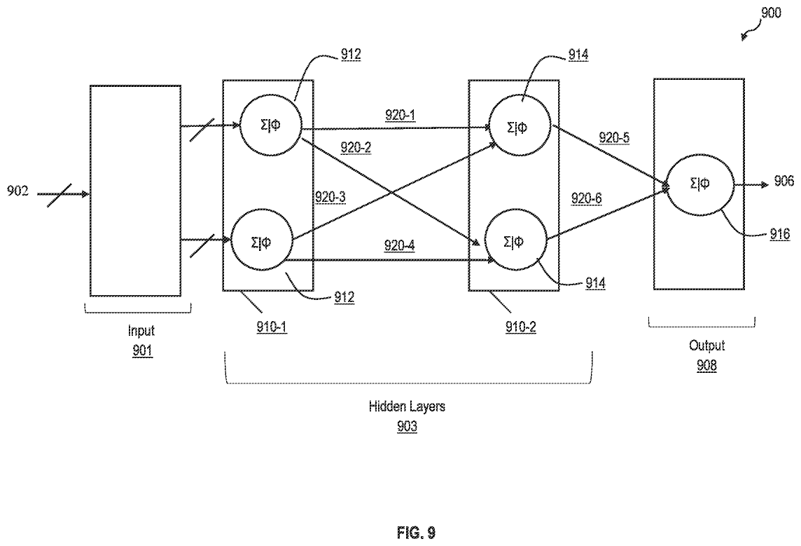

Referring to FIG. 9, a block diagram of a simplified neural network model 900 is shown. The neural network model 900 may include a stack of distinct layers (vertically oriented) that transform a variable number of inputs 902 being ingested by an input layer 904, into an output 906 at the output layer 908.

The neural network model 900 may include a number of hidden layers 910 between the input layer 904 and output layer 908. Each hidden layer has a respective number of nodes (912, 914 and 916). In the neural network model 900, the first hidden layer 910-1 has nodes 912, and the second hidden layer 910-2 has nodes 914. The nodes 912 and 914 perform a particular computation and are interconnected to the nodes of adjacent layers (e.g., nodes 912 in the first hidden layer 910-1 are connected to nodes 914 in a second hidden layer 910-2, and nodes 914 in the second hidden layer 910-2 are connected to nodes 916 in the output layer 908). Each of the nodes (912, 914 and 916) sum up the values from adjacent nodes and apply an activation function, allowing the neural network model 900 to detect nonlinear patterns in the inputs 902. Each of the nodes (912, 914 and 916) are interconnected by weights 920-1, 920-2, 920-3, 920-4, 920-5, 920-6 (collectively referred to as weights 920). Weights 920 are tuned during training to adjust the strength of the node. The adjustment of the strength of the node facilitates the neural network's ability to predict an accurate output 906.

In some embodiments, the output 906 may be one or more numbers. For example, output 906 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a one or more computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions and embodiment of the embodiments without departing from the scope of the present disclosure as expressed in the appended claims.

What is claimed is:

1. A provider computing system comprising:
at least one processing circuit having at least one processor coupled to at least one memory device, the at least one memory device storing instructions thereon that, when executed by the at least one processor, cause the at least one processing circuit to:
detect, responsive to an occurrence of an event associated with an account of a user, initiation of a session to access the account by a user device of the user;
detect, using a machine learning model stored in the at least one memory device, correlations between the event and one or more previous occurrences of one or more events similar to the event, wherein the correlations identify one or more factors that impacted the occurrence of the event;
generate, using the machine learning model, based on the one or more factors, a plurality of actions to address the event;
transmit one or more signals to cause the user device to display a user interface including selectable elements to indicate the plurality of actions;
receive, from the user device, an indication of a selection of a selectable element of the selectable elements, wherein the selectable element is associated with an action of the plurality of actions; and
implement, responsive to receiving the indication, the action to address the event.

2. The provider computing system of claim 1, wherein the instructions further cause the at least one processing circuit to:
retrieve, responsive to detecting initiation of the session, information to detect correlations between the event and the one or more previous occurrences of the one or more events, wherein retrieving the information to detect the correlations includes:
retrieving, from one or more publicly accessible databases, information describing one or more aspects of the event of the one or more events; or
retrieving, from a database associated with a provider, information describing one or more actions previously implemented to address the one or more events; and
detect, using the information retrieved from the database, the correlations between the event and the one or more previous occurrences of the one or more events.

3. The provider computing system of claim 1, wherein the machine learning model includes at least one of:
a Large Language Model;
a generative pre-trained transformer; or
a generative artificial intelligence model.

4. The provider computing system of claim 1, wherein the event includes at least of one of:
a declined transaction request;
an account adjustment request;
a transaction alert;
a payment date; or
a threshold alert.

5. The provider computing system of claim 1, wherein the session includes an authenticated session between the user device and a second user device associated with a provider of the account, and wherein the instruction further cause the at least one processing circuit to:
cause the second user device to display a second user interface to display the plurality of actions and information associated with the plurality of actions, wherein the information associated with the plurality actions is absent from the user interface;
receive, from the second user device, an indication of a request from the user device to receive a portion of the information associated with the action of the plurality of actions;
provide, to the user device, the portion of the information associated with the action to display via the user interface; and
receive, from the user device, the indication of the selection of the selectable element of the selectable elements.

6. The provider computing system of claim 1, wherein the instructions further cause the at least one processing circuit to:
prompt, prior to causing the user device to display the user interface, the user device for a credential to authenticate the user device;
receive the credential from the user device;
update, based on the credential, the plurality of actions to include one or more subsequent actions or to remove one or more actions of the plurality of actions; and
cause the user device to display the user interface, wherein the user interface includes the selectable elements, and wherein the selectable elements correspond to the plurality actions subsequent to updating the plurality of actions.

7. The provider computing system of claim 1, wherein the instructions further cause the at least one processing circuit to:
determine, responsive to a second occurrence of the event, that the user device initiated a second session to access the account;
determine an amount of time elapsed between the occurrence of the event and the second occurrence of the event; and
cause, responsive to the amount of time being less than a threshold, the user device to display a third user interface including a prompt to accept a second implementation of the action.

8. The provider computing system of claim 1, wherein the one or more characteristics of the event include information provided by the user device explaining the event, and wherein the instructions further cause the at least one processing circuit to:
prompt the user device to provide subsequent information to explain one or more aspects of the event;
receive, from the user device, the subsequent information; and
generate the plurality of actions based on the one or more characteristics of the event and the subsequent information.

9. The provider computing system of claim 1, wherein the instructions further cause the at least one processing circuit to:
retrieve information associated with the account;
identify, based on the information associated with the account, one or more actions previously skipped during creation of the account;
predict, based on the one or more actions previously skipped, an occurrence of a second event resulting from an absence to implement the one or more actions;
cause the user device to display a prompt to accept implement of the one or more actions to prevent the occurrence of the second event; and
implement the action to prevent the occurrence of the second event.

10. The provider computing system of claim 1, wherein the instructions further cause the at least one processing circuit to:
cause the user device to display a prompt to accept subsequent implementation of the one or more actions to prevent one or more subsequent occurrences of the event;
receive, from the user device, an indication to accept the subsequent implementation; and
update the account to reflect receiving the indication to accept the subsequent implementation.

11. A method, comprising:
detecting, by a computing system, responsive to an occurrence of an event associated with an account of a user, initiation of a session to access the account by a user device of the user;
detecting, by the computing system using a machine learning model, correlations between the event and one or more previous occurrences of one or more events similar to the event, wherein the correlations identify one or more factors that impacted the occurrence of the event;
generating, by the computing system using the machine learning model, based on the one or more factors, a plurality of actions to address the event;
transmitting, by the computing system, one or more signals to cause the user device to display a user interface including selectable elements to indicate the plurality of actions;
receiving, by the computing system, from the user device, an indication of a selection of a selectable element of the selectable elements, wherein the selectable element is associated with an action of the plurality of actions; and
implementing, by the computing system, responsive to receiving the indication, the action to address the event.

12. The method of claim 11, further comprising:
retrieving, by the computing system, responsive to detecting initiation of the session, information to detect correlations between the event and the one or more previous occurrences of the one or more events, wherein retrieving the information to detect the correlations includes:
retrieving, by the computing system, from one or more publicly accessible databases, information describing one or more aspects of the event of the one or more events; or
retrieving, by the computing system, from a database associated with a provider, information describing one or more actions previously implemented to address the one or more events; and
detecting, by the computing system, using the information retrieved from the database, the correlations between the event and the one or more previous occurrences of the one or more events.

13. The method of claim 11, wherein the machine learning model includes at least one of:
a Large Language Model;
a generative pre-trained transformer; or
a generative artificial intelligence model.

14. The method of claim 11, wherein the event includes at least of one of:
a declined transaction request;
an account adjustment request;
a transaction alert;
a payment date; or
a threshold alert.

15. The method of claim 11, wherein the session includes an authenticated session between the user device and a second user device associated with a provider of the account, and further comprising:
causing, by the computing system, the second user device to display a second user interface to display the plurality of actions and information associated with the plurality of actions, wherein the information associated with the plurality actions is absent from the user interface;
receiving, by the computing system, from the second user device, an indication of a request from the user device to receive a portion of the information associated with the action of the plurality of actions;
providing, by the computing system, to the user device, the portion of the information associated with the action to display via the user interface; and
receiving, by the computing system, from the user device, the indication of the selection of the selectable element of the selectable elements.

16. The method of claim 11, further comprising:
prompting, by the computing system, prior to causing the user device to display the user interface, the user device for a credential to authenticate the user device;
receiving, by the computing system, the credential from the user device;
updating, by the computing system, based on the credential, the plurality of actions to include one or more subsequent actions or to remove one or more actions of the plurality of actions; and
causing, by the computing system, the user device to display the user interface, wherein the user interface includes the selectable elements, and wherein the selectable elements correspond to the plurality actions subsequent to updating the plurality of actions.

17. The method of claim 11, further comprising:
determining, by the computing system, responsive to a second occurrence of the event, that the user device initiated a second session to access the account;
determining, by the computing system, an amount of time elapsed between the occurrence of the event and the second occurrence of the event;
causing, by the computing system, responsive to the amount of time being less than a threshold, the user device to display a third user interface including a prompt to accept a second implementation of the action.

18. The method of claim 11, wherein the one or more characteristics of the event include information provided by the user device explaining the event, and further comprising:
prompting, by the computing system, the user device to provide subsequent information to explain one or more aspects of the event;
receiving, by the computing system, from the user device, the subsequent information; and
generating, by the computing system, the plurality of actions based on the one or more characteristics of the event and the subsequent information.

19. A non-transitory computer-readable storage media having instructions stored thereon that, when executed by at least one processor of a provider computing system, cause the provider computing system to perform operations comprising:
detecting, responsive to an occurrence of an event associated with an account of a user, initiation of a session to access the account by a user device of the user;
retrieving, responsive to detecting initiation of the session, information to detect correlations between the event and the one or more previous occurrences of the one or more events, wherein retrieving the information to detect the correlations includes:
retrieving, from one or more publicly accessible databases, information describing one or more aspects of the event or the one or more events; or
retrieving, by the computing system, from a database associated with a provider, information describing one or more actions previously implemented to address the one or more events;
detecting, using a machine learning model stored in communication with the provider computing system, correlations between the event and one or more previous occurrences of one or more events similar to the event, wherein the correlations identify one or more factors that impacted the occurrence of the event;
generating, using the machine learning model, based on the one or more factors, a plurality of actions to address the event;
transmitting one or more signals to cause the user device to display a user interface including selectable elements to indicate the plurality of actions;
receiving, from the user device, an indication of a selection of a selectable element of the selectable elements, wherein the selectable element is associated with an action of the plurality of actions; and
implementing, responsive to receiving the indication, the action to address the event.

20. The non-transitory computer-readable storage media of claim 19, wherein the session includes an authenticated session between the user device and a second user device associated with a provider of the account, and wherein the instruction further cause the provider computing system to perform operations comprising:
causing the second user device to display a second user interface to display the plurality of actions and information associated with the plurality of actions, wherein the information associated with the plurality actions is absent from the user interface;
receiving, from the second user device, an indication of a request from the user device to receive a portion of the information associated with the action of the plurality of actions;
providing, to the user device, the portion of the information associated with the action to display via the user interface; and
receiving, from the user device, the indication of the selection of the selectable element.
